(19) United States
(12) Patent Application Publication
(10) Pub. No.: US 2007/0031089 A1
(43) Pub. Date: Feb. 8, 2007

(54) High efficient LED to fiber coupling

(76) Inventors: Thomas Tessnow, Weare, NH (US); Charles Coushaine, Rindge, NH (US)

Correspondence Address: OSRAM SYLVANIA INC, 100 ENDICOTT STREET, DANVERS, MA, 01923, US

(21) Appl. No.: 11/443,833

(22) Filed: May 31, 2006

Related U.S. Application Data
(60) Provisional application No. 60/705,744, filed on Aug. 5, 2005.

(51) Int. Cl. G02B 6/30; G02B 6/42

(52) U.S. Cl. 385/49; 385/88

(57) ABSTRACT

A coupling assembly for mechanically and optically coupling an LED to a fiber optic. The assembly has a light guide with an axis and has a first end including an input window to receive light from the LED. The input window is formed to interface with the LED. A second end includes an output window. A light transmissive body extends axially from the input window to the output window, and a housing has a support coupling to the light guide. A first wall extends from the support to a coupling face adjacent the input window, the coupling face being formed to interface with the support for the LED. A second wall extends from the support adjacent the output window and defines an output recess with the output window defining an internal end wall of the output recess. The recess is formed to receive an end of the fiber optic.

### CROSS-REFERENCE TO RELATED APPLICATION

This application claims priority from Provisional Patent Application No. 60/705,744, filed Aug.05, 2005.

### TECHNICAL FIELD

The invention relates to optical structures. More particularly the invention is concerned with a light guide coupling to join an LED to a fiber optic.

### BACKGROUND ART

A common problem with coupling existing LED packages to fiber optics is that the emission angle from the package does not fit the acceptance angle of the fibers. The LED chip is too deep in the LED package. It is too far away from the fiber. A simple solution is to minimally re-modify the existing LED package, but that solution is not available to users of the LED packages. There is a need for a LED package-to-fiber optic coupling that improves light gathering. A standard LED package by itself couples only 80 percent of the emitted light over an angle of +/−90 degrees from the axial into the air minus the light lost in following optics to bring the light into the +/−30 degrees acceptance angle of the fiber.

There are problems with mounting and aligning LED packages with fiber optics. These include mechanical tolerances and the tolerance stack-up by multiple parts such as optic-to-board and the board-to-LED package and the LED package-to-LED chip. The distance of the optic to the chip needs to be held very close as well.

There is a need to couple as much light as possible from an LED chip into a optical fiber with a typical acceptance angle of ±30° (NA=0.5) and keep the exit diameter, that is the entrance into the fiber, small, say about 3mm in diameter. Typically LEDs packages have one side soldered to a support, and then a fiber optic is glued to a second side of the LEDs. Because the fiber optic glues cannot withstand the high temperature of the LED soldering (reflow) process, the fiber optic is glued in place after the LED is on the PCB-board. This means the fiber optic has to be properly registered to the LED chip. There is then a need for a convenient mechanism for registering the LED chip to the fiber for gluing.

There is a need for an optical coupling to collimate the light from an LED chip into an optical fiber. Complex Parabolic Concentrators (CPCs) are known and have been used with LEDs. Most existing optical coupling solutions use LED packages, which have light emitting surfaces that are larger than 2mm by 2mm. Therefore, there is not enough space to collimate the light.

An integrated package with chip and optic solution would require the optic coupling to be molded onto the chip and would have to go through the soldering process, which requires high temperature plastics, which might not be optically efficient or might be expensive.

Even if the optical coupling could withstand the soldering reflow process, the optical coupling and LED assembly would be tall and likely to tip over or otherwise lose its registration when the solder reflow contacted the assembly.

A standard or advanced LED package such as Power TopLED (APT or PT) packages emit about 80 percent of the LED chip's emitted light. The emission is lambertian (distributed into a hemisphere) and therefore has an inefficient coupling to a clad fiber with a typical acceptance angle of about +/−30° from the axial. An optic could be designed to improve the coupling, but the total coupling efficiency would be always less than the 80 percent emitted at the LED package. The main problem is that standard LED packages have a thick epoxy layer above the chip and do not allow the optical coupling to come close enough to the chip to improve the input angle. A larger entrance surface could increase the collection efficiency, but would require a proportionally larger exit surface to achieve the same small emission angle to match the fibers acceptance angle. Thicker solid fibers are less flexible and require large bending radii. Plastic fiber up to 3mm diameter is inexpensive and easily available. Fiber bundles can have large diameters and be flexible, but, even with the tidiest packing of the circular cross-section fibers, there is always a space between the fibers because of their circularity, which results in a typical light loss of at least 20 percent.

### DISCLOSURE OF INVENTION

It is, therefore, an object of the invention to obviate the disadvantages of the prior art.

It is another object of the invention to enhance the operation of LED light source.

It is yet another object of the invention to enhance the coupling between an LED light source and an optical fiber.

These objects are accomplished, in one aspect of the invention, by the provision of a coupling assembly for mechanically and optically coupling an LED light source having a support to a fiber optic, the coupling assembly comprising: a light guide extending along a longitudinal axis having a first end including a light input window for the receipt of light from the LED light source, the input window being sized and shaped to interface with the LED light source, a second end including a light output window, and a light transmissive body extending axially from the light input window to the light output window and a housing having a support coupling to the light guide, a first wall extending from the support to a coupling face adjacent the input window, the coupling face being sized and shaped to interface with the support for the LED light source, and a second wall extending from the support adjacent the output window and defining an output recess with the output window defining an internal end wall of the output recess, the recess being sized and shaped to receive an input end of the fiber optic.

### BRIEF DESCRIPTION OF THE DRAWINGS

FIG. 1 is a diagrammatic sectional view of an embodiment 6 of the invention;

FIG. 2 is a sectional view taken along the line 2-2 of FIG. 1;

FIG. 3 is a view similar to FIG. 2 but of an alternate embodiment; and

FIG. 4 is a plan view of an array of couplers.

### BEST MODE FOR CARRYING OUT THE INVENTION

For a better understanding of the present invention, together with other and further objects, advantages and capabilities thereof, reference is made to the following disclosure and appended claims taken in conjunction with the above-described drawings.

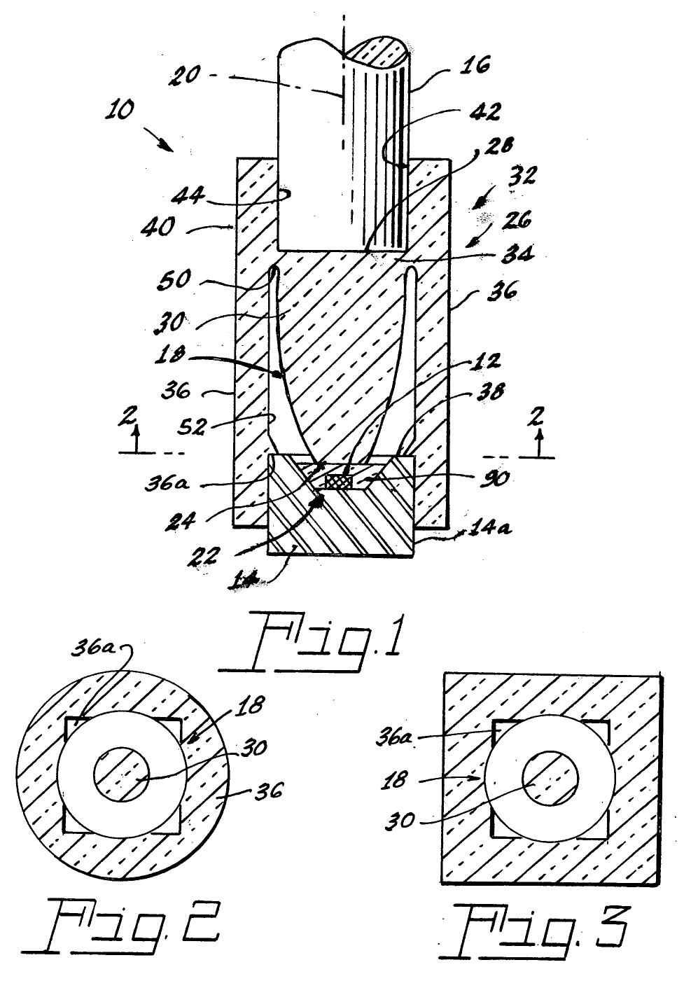

Referring now to FIG. 1, there is shown a coupling assembly 10 for mechanically and optically coupling an LED light source 12 having a support 14 to a fiber optic 16. The coupling assembly 10 comprises an optic such as complex parabolic concentrator (CPC) and can be a light guide 18 extending along a longitudinal axis 20 and having a first end 22 that includes a light input window 24 for the receipt of light from the LED light source 12. The input window 24 is transverse to the axis 20 and is sized and shaped to interface with the LED light source 12. A second end 26 includes a light output window 28 transverse to the axis 20 and thus parallel to the input window 24. A light-transmissive body 30 that comprises a body of revolution about the longitudinal axis 20 extends axially from the light input window 24 to the light output window 28. The body 30 thus has a sidewall 30a, which monotonically increases in diameter from the light input 24 window to the light output window 28.

A housing 32 has a support 34 that couples the light guide 18 to the optic fiber 16 and includes a first wall 36 that extends from the support 34 to a coupling face 38 adjacent the input window 24, the coupling face 38 being sized and shaped to interface with the support 14 for the LED light source 12. The first wall 36 defines a recess that is sized, shaped and aligned to axially envelope the housing 14 for the LED 12 and transaxially register with sidewalls 14a of the LED support. A second wall 40, which is an extension of the wall 36, extends from the support 34 adjacent the output window 28 and defines an output recess 42 with the output window 28 and an internal end wall 44 of the output recess, the recess 42 being sized and shaped to receive an input end 46 of the fiber optic 16 and. In a preferred embodiment, is cylindrical

In a preferred embodiment, the light guide 18 and housing 32 are a unitary body coupled along an exterior edge 50 of the output window.

An interior portion 52 of the first wall 36 includes a registration face 36a abutting the support 14 for the LED light source 12 and is seen more clearly in FIG. 2

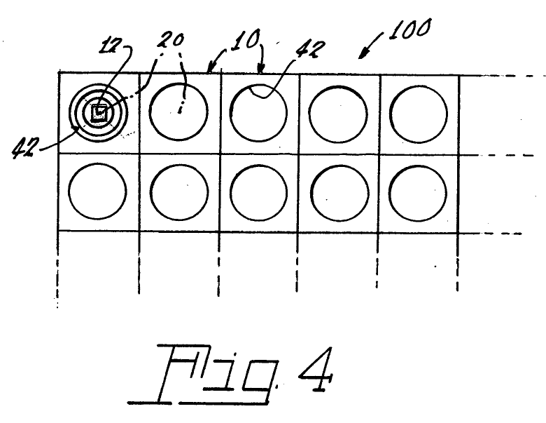

When it is desired to employ a plurality of LEDs 12, they can be arranged in an X-Y pattern as shown in FIG. 4. Therein a coupling 100 comprises a plurality of coupling assemblies 10, arranged in an array with each respective longitudinal axis 20 being parallel, the coupling assemblies 10 being in registration with and coupled with a corresponding plurality of LEDs 12 arranged in an X-Y array on a single support, The coupling 100 provides a plurality of recesses 42 for a corresponding plurality of fiber optics 16. When used in an array as shown in FIG. 4 it is preferable that the coupling assemblies 10 be square in cross-section, as shown in FIGS. 3 and 4.

In either embodiment, a thin layer of an encapsulant such as an optical sealer or index-matching glue 90, fills the space about the LED 12 to a height less than the height of the support 14, thus allowing the CPC to get closer to the LED 12. The input window 24 contacts the glue surface thus ensuring good light coupling. Also, if the LED chip is only barely covered by the encapsulant 90 the LED can be soldered onto a printed circuit board, e.g., by a reflow solder technique, and the optic 18 can be glued on afterward.

The use of the lesser amount of encapsulant, which is permitted by the use of coupling assembly described herein, allows the CPC to get closer to the LED chip 12, thus increasing light collection efficiency.

While there have been shown and described what are at present considered to be the preferred embodiments of the invention, it will be apparent to those skilled in the art that various changes and modifications can be made herein without departing from the scope of the invention as defined by the appended claims.

What is claimed is:

1. A coupling assembly for mechanically and optically coupling an LED light source having a support to a fiber optic, the coupling assembly comprising:
a light guide extending along a longitudinal axis having a first end including a light input window for the receipt of light from the LED light source, the input window being sized and shaped to interface with the LED light source, a second end including a light output window, and a light transmissive body extending axially from the light input window to the light output window, and
a housing having a support coupling to the light guide, a first wall extending from the support to a coupling face adjacent the input window, the coupling face being sized and shaped to interface with the support for the LED light source, and a second wall extending from the support adjacent the output window and defining an output recess with the output window defining an internal end wall of the output recess, the recess being sized and shaped to receive an input end of the fiber optic.

2. The coupling assembly of claim 1, wherein the light input window is transverse to the axis.

3. The coupling assembly of claim 1, wherein the light output window is transverse to the axis.

4. The coupling assembly of claim 1, wherein said light transmissive body is a body of revolution about the axis.

5. The coupling assembly of claim 1, wherein the light transmissive body includes a sidewall which monotonically increases in diameter from the light input window to the light output window.

6. The coupling assembly of claim 1, wherein the light guide and housing are a unitary body coupled along an exterior edge of the output window.

7. The coupling assembly of claim 1, wherein an interior portion of the first wall includes a registration face abutting the support for the LED light source.

8. The coupling assembly of claim 1, wherein the first wall includes a coupling latching to the support for the LED light source.

9. The coupling assembly of claim 1, wherein the output recess is cylindrical.

10. The coupling assembly of claim 1, wherein the light guide and housing are coupled as a unitary body of rotation joined along said bridge support which extends radially adjacent the plane of the output window.

11. The coupling assembly of claim 1, wherein the first wall defines a recess sized, shaped and aligned to axially envelope the housing for the LED and transaxially register with sidewalls of the LED support.

12. A coupling comprising a plurality of coupling assemblies as in claim 1, arranged in an array with each respective longitudinal axis being parallel, the coupling assemblies being in registration with and coupled with a corresponding plurality of LEDs arranged in an X, Y array on a single support, the coupling providing a plurality of recesses for a corresponding plurality of fiber optics.
